(19) United States
(12) Patent Application Publication
(10) Pub. No.: US 2009/0183819 A1
(43) Pub. Date: Jul. 23, 2009

(54) Manufacturing method for a display device

(76) Inventor: Tsutomu Matsuhira, Chiba-shi (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/317,440

(22) Filed: Dec. 23, 2008

(30) Foreign Application Priority Data
Dec. 27, 2007 (JP) 2007-336673
Nov. 17, 2008 (JP) 2008-293635

(51) Int. Cl. B32B 37/02

(52) U.S. Cl. 156/99

(57) ABSTRACT

It is aimed to, in a manufacturing method for a display device including a translucent substrate bonded to a display panel using a translucent adhesive, realize a bright display screen free from an air layer formed between the display panel and the translucent substrate. For this purpose, a first adhesive layer made of a first adhesive is formed between a frame body and an exposed surface of an upper portion of the display panel, a second adhesive is next applied onto a surface of the translucent substrate, and the surface applied with the second adhesive is faced downward and is bonded to a top surface of the display panel including the first adhesive layer formed thereon, to thereby cure the second adhesive. Accordingly, the adhesive can be filled between the top surface of the display panel and a bottom surface of the translucent substrate without trapping bubbles or voids therebetween.

### BACKGROUND OF THE INVENTION

1. Field of the Invention

The present invention relates to a manufacturing method for a display device including a translucent substrate which is bonded to a display surface of the display device with a translucent adhesive.

2. Description of the Related Art

The display surface of the display panel is provided with a cover glass for protection of the display surface or for shock resistance. Further, there is also known a display device in which a touch panel is provided in place of the cover glass. However, when an air layer is interposed between the display panel and the cover glass or the touch panel, light is reflected on the surface of the display panel or on a bottom surface of the cover glass or the touch panel, which causes a problem in that the display surface is darkened due to reflection loss. In order to solve the above-mentioned problem, there is proposed a method of filling a transparent adhesive having a refractive index close to a refractive index of the glass between the display panel and the cover glass or the touch panel. With this structure, the reflection loss occurring on the surface on the display side of the display panel or on a surface on the display panel side of the cover glass can be reduced. Moreover, the cover glass and the display panel are integrated with each other by the adhesive, which is advantageous in improving impact resistance.

JP 09-274536 A describes a display device with a touch panel, in which a transparent adhesive is filled between the touch panel and the display panel. The method of filling the transparent adhesive between the touch panel and the display panel is as follows. First, the touch panel is applied with the transparent adhesive with its rear surface facing upward. Then, the touch panel is reversed to form a drip of the transparent adhesive. Then, the touch panel having the drip formed thereon is gradually lowered from above the display panel to be bonded to the display panel. When the translucent substrate is lowered, a tip of the drip formed of the transparent adhesive is brought into contact with the surface of the display panel, and the contact area gradually spreads toward the periphery thereof. Through filling as described above, the transparent adhesive can be prevented from trapping bubbles.

FIG. 11A is a cross-sectional view illustrating a method of bonding a protective glass substrate 61 to a liquid crystal panel 58 employing the above-mentioned method. The liquid crystal panel 58 includes an upper glass substrate 51, a lower glass substrate 52 bonded to the upper glass substrate 51 so as to form space therebetween by a sealing member 54, liquid crystal 53 filled in the space, an IC 57 mounted onto a bottom surface of the upper glass substrate 51 at its end portion, an upper polarizing plate 55 bonded to an external surface of the upper glass substrate 51, and a lower polarizing plate 56 bonded to an external surface of the lower glass substrate 52. The liquid crystal panel 58 is provided with a backlight 59 in a lower portion thereof. The liquid crystal panel 58 is provided with a frame body 60 on a periphery thereof, and the frame body 60 is provided with an opening 65 formed in its upper portion so that a display surface of the liquid crystal panel 58 can be seen.

A liquid transparent adhesive 62 is applied onto a surface of the protective glass substrate 61 bonded to the display surface side of this structure. As the transparent adhesive 62, a UV curable transparent adhesive is used. The protective glass substrate 61 has a shape slightly larger than the opening 65 located in an upper portion of the frame body 60, and overlaps an upper end portion 66 of the opening 65. The transparent adhesive 62 has viscosity of 1,000 to 6,000 mPa·s and forms a drip when being reversed. The protective glass substrate 61 is gradually lowered in a direction indicated by an arrow, whereby the protective glass substrate 61, the upper end portion 66 of the frame body 60, and the liquid crystal panel 58 are integrally bonded to each other. Ultraviolet rays are irradiated in bonding.

FIG. 11B is a cross-sectional view illustrating a state in which the protective glass substrate 61, the upper end portion 66 of the frame body 60, and the liquid crystal panel 58 are bonded to each other. FIG. 11C is a top view thereof. The upper end portion 66 of the frame body 60 has a plate thickness of about 0.3 mm. There is a gap of 0 mm to 0.3 mm between the upper end portion 66 and the upper polarizing plate 55 or a top surface of the upper glass substrate 51. In the case where there is the gap between the upper end portion 66 of the frame body 60 and the upper polarizing plate 55 or the upper glass substrate 51, as indicated by an arrow 63, the transparent adhesive 62 flows between the liquid crystal panel 58 and the frame body 60 to reach the backlight 59, which leads to a problem that maintenance of the backlight 59 or the like cannot be performed.

Further, when there is no gap between the upper end portion 66 of the frame body 60 and the upper polarizing plate 55 or the upper glass substrate 51, a void 64 is formed at a tip of the upper end portion 66. As illustrated in FIG. 11C, when the void 64 is formed at a corner portion or a right side portion of the opening 65 of the frame body 60, the void 64 is inadvertently seen. Further, the volume of the transparent adhesive 62 is reduced when being cured. When the volume of the transparent adhesive 62 is reduced, a tensile stress is applied to the display surface of the liquid crystal panel 58, which leads to a problem that warping of the liquid crystal panel or irregular thickness of a liquid crystal layer is caused to generate irregular colors.

### SUMMARY OF THE INVENTION

In order to solve the above-mentioned problems, in the present invention, a display panel is disposed inside a frame body having an opening on its top portion in adjacent to an end portion of the opening of the frame body, and then a first adhesive layer is formed by filling a first adhesive on an exposed surface of the display panel, which is exposed from the opening of the frame body. A step between the opening end portion of the frame body and a surface of the display panel is filled by the first adhesive layer, whereby a void can be prevented from being generated in an upper end corner portion or a corner portion of the frame body. Then, the surface of the translucent substrate disposed outside the opening is applied with a second adhesive, and the translucent substrate applied with the second adhesive is bonded to a top surface of the display panel including the first adhesive layer formed thereon with the surface applied with the second adhesive being a bottom surface, to thereby cure the second adhesive. In this manner, the adhesive can be filled between the top surface of the display panel and the bottom surface of the translucent substrate without trapping bubbles or voids therebetween.

Further, in the step of forming the first adhesive layer, the first adhesive layer is formed on the exposed surface of the display panel, which is exposed from the opening of the frame body, so that a height of the first adhesive layer is substantially equal to a height of the top surface of the opening end portion.

Further, in the step of forming the first adhesive layer, the first adhesive is cured before the translucent substrate is bonded. When the first adhesive is cured before the second adhesive is applied and cured, a stress applied to the display panel by cure shrinkage can be reduced.

Further, an adhesive dam is formed between the display panel and the frame body before the first adhesive layer is formed. Accordingly, the first adhesive can be prevented from leaking and dropping down a side surface of the display panel to adhere to other element.

Further, in the step of applying the second adhesive, the surface is applied with an adhesive having relatively high viscosity, and then is applied with an adhesive having relatively low viscosity.

Further, the first adhesive and the second adhesive each have cure shrinkage within a range of 1% to 6%. In this case, materials having a substantially equal refractive index after being cured are selected for the first adhesive and the second adhesive.

### BRIEF DESCRIPTION OF THE DRAWINGS

In the accompanying drawings:

FIGS. 1A to 1E are explanatory views illustrating a manufacturing method for a display device according to the present invention step by step;

FIG. 2 is a top view of a display device manufactured by the manufacturing method according to the present invention;

FIGS. 3A to 3E are explanatory views for describing cure shrinkage of an adhesive;

FIGS. 4A to 4E are explanatory views illustrating the manufacturing method for a display device according to the present invention step by step;

FIGS. 5A to 5D are explanatory views illustrating the manufacturing method for a display device according to the present invention step by step;

FIGS. 6A to 6D are explanatory views illustrating the manufacturing method for a display device according to the present invention step by step;

FIGS. 7A to 7D are explanatory views illustrating the manufacturing method for a display device according to the present invention step by step;

FIGS. 8A and 8B are explanatory views illustrating the manufacturing method for a display device according to the present invention step by step;

FIGS. 9A to 9C are explanatory views for describing a second adhesive applying step of the manufacturing method according to the present invention;

FIGS. 10A to 10C are explanatory views for describing the second adhesive applying step of the manufacturing method according to the present invention; and

FIGS. 11A and 11B are cross-sectional views of a display device according to a conventionally-known manufacturing method, and FIG. 11C is a top view thereof.

### DETAILED DESCRIPTION OF THE PREFERRED EMBODIMENTS

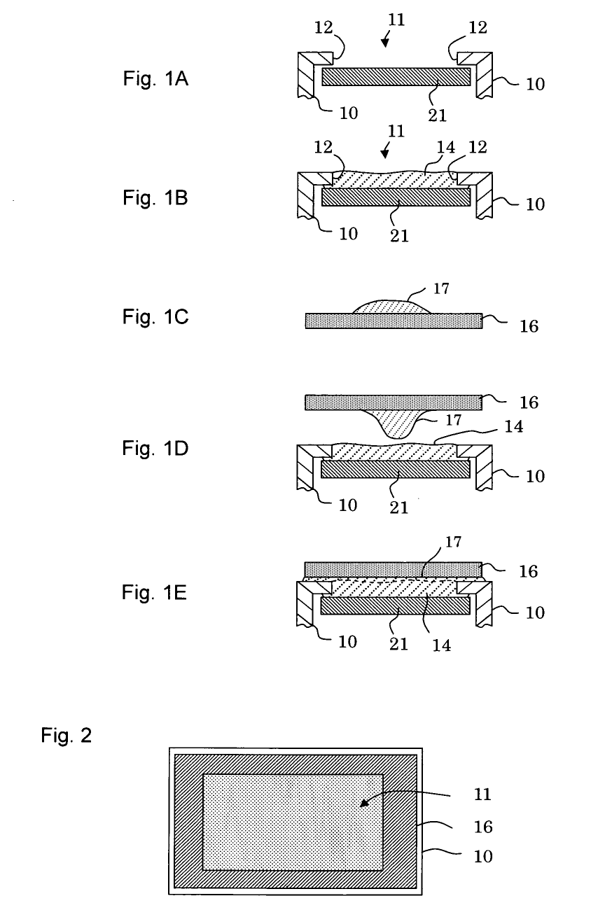

A manufacturing method for a display device according to the present invention is described with reference to FIGS. 1A to 1E step by step. FIG. 1A is a schematic view illustrating a disposing step. A frame body 10 of the display device is provided with an opening 11 in its top portion. A display panel 21 is provided in proximity to the opening 11 inside the frame body 10. An opening end portion 12 of the frame body 10 and a top surface of the display panel 21 may be provided with a gap, or may be brought into contact with each other. FIG. 1B is a schematic view illustrating a first adhesive layer forming step. A first adhesive layer 14 made of a translucent first adhesive is formed on the top surface of the display panel 21 so as to extend to the opening end portion 12 of the frame body 10. FIG. 1C is a schematic view illustrating a second adhesive applying step. A translucent second adhesive 17 is applied onto a surface of a translucent substrate 16. The second adhesive 17 is applied onto the surface of the translucent substrate 16 in a dot shape. For example, one dot of the second adhesive 17 is applied onto a center portion of the surface of the translucent substrate 16, or four dots thereof are further applied onto corner portions of the surface of the translucent substrate 16. An application amount of the second adhesive 17 is an amount so that an entire surface of the display panel 21 can be applied with a thickness of about 0.05 to 0.3 mm.

FIG. 1D is a schematic view illustrating a bonding step. The translucent substrate 16 which is turned upside down is disposed above the first adhesive layer 14. When the translucent substrate 16 is disposed, alignment among the translucent substrate 16, the display panel 21, and the frame body 10 is performed. A drip is formed by the second adhesive 17 by the action of gravity. In this state, the translucent substrate 16 is gradually lowered. The translucent substrate 16 is lowered at speed at which a wave pattern is not generated on a surface of the drip. For example, the translucent substrate 16 is lowered at speed of 5 to 100 μm/sec. For example, in the case where viscosity of the second adhesive 17 to be used is 2,000 to 3,000 mPa·s, a descending speed is set to about 20 μm/sec. Then, a contact area between the second adhesive 17 and the first adhesive layer 14 is enlarged to fill the second adhesive 17 over an entire bottom surface of the translucent substrate 16. FIG. 1E illustrates a second adhesive curing step. Heating is performed in the case of using a thermosetting adhesive as the second adhesive 17, ultraviolet rays are irradiated in the case of using a UV curable adhesive, and visible rays are irradiated for curing in the case of using a visible light curable adhesive.

FIG. 2 is a top view of the display device after the second adhesive curing step. The translucent substrate 16 is bonded inside the frame body 10, and thus the display surface of the display panel 21 is seen from the opening 11. A step formed between the opening end portion 12 of the frame body 10 and the surface of the display panel 21 is filled with the first adhesive, or the step is decreased, with the result that no void is left in an upper end corner portion or a corner portion of the frame body 10. Further, when refractive indices of the first adhesive layer 14 and the second adhesive 17 are made to be close to refractive indices of the translucent substrate 16 and the display panel 21, respectively, reflection loss of light occurring between the translucent substrate 16 and the display panel 21 and reflection loss of light occurring between the first adhesive layer 14 and the second adhesive 17 can be reduced.

In the manufacturing method for a display device, as the display panel 21, a flat display panel such as a liquid crystal panel, a plasma display panel, or an organic EL panel can be used. As the translucent substrate 16, a flat-plate transparent substrate such as a glass substrate for display surface protection, a transparent plastic substrate made of polycarbonate or acryl, or an input touch panel can be used. As the first adhesive and the second adhesive 17, a transparent adhesive such as a thermosetting adhesive, a UV curable adhesive, or a visible light curable adhesive can be used. As the first adhesive and the second adhesive, different types of adhesives among the above-mentioned adhesives may be used in combination. As the frame body 10, metal, plastic, ceramic, or the like can be used.

In the first adhesive layer forming step, the first adhesive layer 14 is formed up to a height substantially equal to a height of the top surface of the opening end portion 12 on an exposed surface of the display panel 21, which is exposed from the opening 11 of the frame body 10. As a result, there is almost no step between the top surface of the opening end portion 12 and the top surface of the first adhesive layer 14, which is advantageous in that a void caused by the second adhesive 17 is hardly generated in this portion.

Further, prior to the first adhesive layer forming step, a double-sided tape is provided between the top surface of the display panel 21 and the opening end portion 12 of the frame body 10, and hence the gap formed between the opening end portion 12 of the frame body 10 and the surface of the display panel 21 can be filled to forman adhesive dam. Accordingly, when the first adhesive is applied in the first adhesive layer forming step, the double-sided tape functions as the dam, and hence the first adhesive leaks out of the gap between the opening end portion 12 of the frame body 10 and the display panel 21 and drops down a side surface of the display panel 21, which can prevent the first adhesive from adhering to other element.

Alternatively, prior to the first adhesive layer forming step, an adhesive dam formed of a third adhesive can be formed between the opening end portion 12 of the frame body 10 and the display panel 21. After that, the first adhesive is applied onto a concave portion formed of the adhesive dam and the exposed surface of the display panel 21. As a result, in the case where there is a gap between the opening end portion 12 of the frame body 10 and the display panel 21, the first adhesive can be prevented from leaking out from the gap and dripping down the side surface of the display panel 21 to adhere to the other element. It is desirable that, as the third adhesive which forms the dam and the first adhesive applied onto the exposed surface of the display panel 21, adhesives having substantially the same refractive index be used. This is because the reflection of light on an interface can be avoided. Further, the third adhesive is prevented from spreading over the surface of the display panel 21 when being applied. For this reason, the viscosity of the third adhesive is preferably set to 40,000 to 80,000 mPa·s.

Further, in the case of forming the adhesive dam with the third adhesive, an upper end portion of the adhesive dam is formed to be higher than the top surface of the opening end portion 12. Accordingly, the sectional side surface of the opening end portion 12 is covered with the third adhesive. Thus, in the bonding step performed later, a void is hardly generated in its step portion when the second adhesive 17 flows into the opening 11. Further, in the case where an outer shape of the translucent substrate 16 is larger than an outer shape of the opening 11, the second adhesive 17 is likely to spread outside the opening 11 when the second adhesive 17 flows into the opening 11, which facilitates filling of the second adhesive 17 over an entire bottom surface of the translucent substrate 16.

Further, in the first adhesive layer forming step, the first adhesive can be cured prior to the attaching step of attaching the translucent substrate 16. As a result, a stress of the adhesive filled between the translucent substrate 16 and the display panel 21, which is generated as a result of cure shrinkage, can be reduced. This is effective in the case of using different curable adhesives, for example, a thermosetting adhesive for the first adhesive and a UV curable adhesive for the second adhesive.

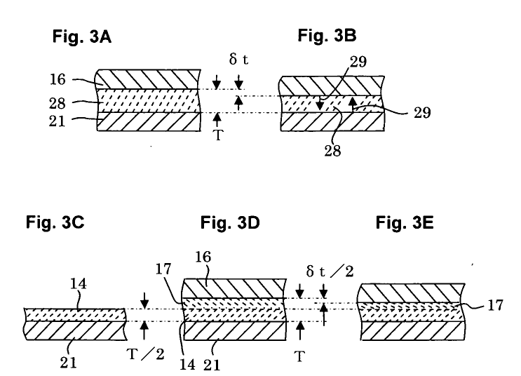

FIGS. 3A to 3E are schematic cross-sectional views of the display panel 21, the adhesive 28, and the translucent substrate 16 for describing the stress generated as a result of cure shrinkage of the adhesive. FIG. 3A is a cross-sectional view illustrating a state in which the adhesive 28 having a thickness T is filled between the display panel 21 and the translucent substrate 16. The adhesive 28 has yet to be cured. FIG. 3B is a cross-sectional view illustrating a state in which the adhesive 28 of FIG. 3A is cured. As a result of cure shrinkage, the adhesive 28 shrinks by a thickness δt. End portions of the display panel 21 and the translucent substrate 16 are fixed through the opening end portion 12 of the frame body 10. For this reason, there is generated a tensile stress 29 toward the adhesive 28 on the top surface of the display panel 21 and the bottom surface of the translucent substrate 16. For example, in the case where the display panel 21 is the liquid crystal panel, the liquid crystal panel is warped, or upper substrates of the two substrates forming the liquid crystal panel are pulled above. Accordingly, a thickness of the liquid crystal layer is changed to generate irregular colors or the like.

FIGS. 3C to 3E are cross-sectional views for describing the manufacturing method for a display device according to the present invention. FIG. 3C illustrates a state in which the first adhesive layer 14 formed on the display panel 21 is cured in the first adhesive layer forming step. Heating and curing are performed in the case of using a thermosetting adhesive as the first adhesive, ultraviolet rays are irradiated for curing in the case of using a UV curable adhesive as the first adhesive, or visible rays are irradiated for curing in the case of using a visible light curable adhesive as the first adhesive. A thickness of the cured first adhesive layer 14 is assumed to be T/2. Even when cure shrinkage is generated in the first adhesive layer 14 at the time of curing, nothing is formed on the top surface of the first adhesive layer 14, whereby the stress is not applied to the display panel 21 provided thereunder.

FIG. 3D illustrates the attaching step, which illustrates a state in which the second adhesive 17 is filled between the first adhesive layer 14 and the translucent substrate 16. The second adhesive 17 is filled to have the thickness of T/2, and an entire thickness of the first adhesive layer 14 and the second adhesive 17 is assumed to be T. FIG. 3E illustrates a state in which the second adhesive 17 is cured, whereby cure shrinkage is generated. An amount of cure shrinkage is δt/2, corresponding to a half of an amount of cure shrinkage illustrated in FIG. 3B. In other words, when the adhesive previously applied is cured first, the stress applied to the display panel 21 as a result of cure shrinkage can be reduced. It should be noted that cure shrinkage ratios of the first adhesive and the second adhesive 17 are preferably small. In the present invention, for example, even when an adhesive having cure shrinkage ratio in a range of 1% to 6%, effects of the stress applied to the display panel can be reduced.

In the second adhesive applying step, the translucent substrate 16 is applied with an adhesive having relatively high viscosity, and then can be applied with an adhesive having low viscosity. In the manufacturing method for a liquid crystal display device according to the present invention, in the attaching step, the drip formed of the adhesive is formed on the translucent substrate 16 to fill the adhesive between the translucent substrate 16 and the display panel 21. However, as the surface area of the display panel 21 increases, an amount of the adhesive to be used increases. Then, the adhesive having relatively high viscosity is applied onto the surface of the translucent substrate 16, and thereafter, an adhesive having lower viscosity compared with the above-mentioned adhesive is applied to enlarge an area in which the adhesive is applied. Specifically, an adhesive having viscosity of 5,000 to 10,000 mPa·s is applied onto the translucent substrate 16, and then, an adhesive having viscosity of 1,000 to 6,000 mPa·s, or more preferably, 2,000 to 3,000 mPa·s is applied. When the translucent substrate 16 is turned upside down, the drip is formed mainly of the adhesive having low viscosity. When the adhesive is applied in two steps in this manner, the translucent substrate 16 can be bonded to the display panel 21 having a large area without trapping bubbles. It should be noted that, in the present invention, application of the adhesive is not limited to two steps, and can be performed in more steps. In this case, the viscosity of the most recently applied adhesive is lowered than the viscosity of the previously applied adhesive.

Hereinafter, the manufacturing method for a display device according to the present invention is described in detail with reference to the drawings. The same portions or the portions having the same function are denoted by the same reference numerals. In the respective embodiments described below, the liquid crystal panel is used as the display panel.

### Embodiment 1

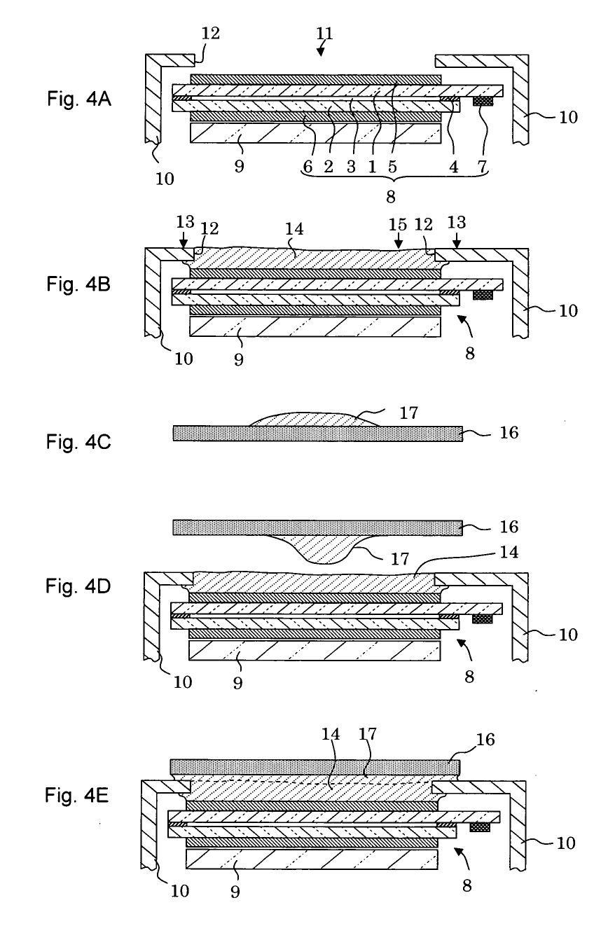

The manufacturing method for a display device according to this embodiment is described with reference to FIGS. 4A to 4E. FIG. 4A illustrates a cross-sectional structure of a liquid crystal panel 8 and the frame body 10, which illustrates a disposing step. In the liquid crystal panel 8, an upper substrate 1 made of glass is bonded to a lower substrate 2 made of glass to opposed to each other through a sealing material 4, and a liquid crystal layer 3 is formed therebetween. A TFT matrix array is formed on an inner surface of the upper substrate 1, and a color filter is formed on an inner surface of the lower substrate 2. Aright side of the upper substrate 1 protrudes compared with the lower substrate 2, and a bottom surface of the protruding portion is mounted with a driver IC 7 for driving the TFT array by a COG method. An upper polarizing plate 5 and a lower polarizing plate 6 are bonded to an outer surface of the upper substrate 1 and an outer surface of the lower substrate 2, respectively. The liquid crystal panel 8 is provided with a backlight 9 on its lower portion. The liquid crystal panel 8 and the backlight 9 are placed in, for example, a housing (not shown). The liquid crystal panel 8 includes a display screen of several inches to 15 inches.

The frame body 10 is formed of a metal plate and includes the opening 11 on its upper end, and a lower portion thereof is fixed to the housing (not shown). The opening 11 is partitioned by the opening end portion 12. The liquid crystal panel 8 is placed in proximity to the opening end portion 12 of the frame body 10. A plate thickness of an end portion of the opening end portion 12 is about 0.3 to 0.6 mm. A tip of the opening end portion 12 extends to a part in which the opening end portion 12 overlaps a periphery region of the upper polarizing plate 5 in plan view. A gap between a bottom surface of the opening end portion 12 and a top surface of the upper polarizing plate 5 is larger than 0 mm and is about 0.3 mm at most.

FIG. 4B is a cross-sectional view illustrating a state in which the first adhesive layer 14 is formed on the top surface of the liquid crystal panel 8, which illustrates the first adhesive layer forming step. The top surface of the liquid crystal panel 8 is applied with the first adhesive. On this occasion, the adhesive is applied up to the opening end portion 12. As the first adhesive, a transparent adhesive of UV curable type is used. The viscosity of the first adhesive is 1,000 to 6,000 mPa·s. Then, ultraviolet rays of 3,000 to 10,000 mJ/cm² are irradiated to cure the first adhesive. As to the first adhesive layer 14, a top surface 13 of the opening end portion 12 of the frame body 10 is made to have a height substantially equal to that of a top surface 15 of the first adhesive layer 14. Irregularities of the top surface of the first adhesive are permissible up to about 100 μm, and preferably, is 100 μm or less.

FIG. 4C is a cross-sectional view illustrating a state in which the top surface of the translucent substrate 16 is applied with the second adhesive 17, which illustrates the second adhesive applying step. As the translucent substrate 16, a glass substrate is used. As the second adhesive 17, a translucent UV curable adhesive is used. The viscosity of the second adhesive 17 is 1,000 to 6,000 mPa·s. If the viscosity of the second adhesive 17 is increased, the drip is hard to be formed when the translucent substrate 16 is reversed in the following bonding step. If the viscosity thereof is reduced, an amount of drips is reduced, and hence an amount of the second adhesive 17 filled between the liquid crystal panel 8 and the translucent substrate 16 is insufficient.

FIG. 4D illustrates a cross-sectional structure of the translucent substrate 16, in which the surface applied with the second adhesive 17 is caused to be a bottom surface above the liquid crystal panel 8, illustrating a bonding step. The top surface and the bottom surface of the translucent substrate 16 are reversed so that the second adhesive 17 is located below the translucent substrate 16. Then, the second adhesive 17 is formed to form a drip by gravity. In this state where the drip is formed, the translucent substrate 16 is lowered to the exposed surface of the liquid crystal panel 8. Accordingly, a tip of the drip becomes in a state of point-contact with the surface of the first adhesive layer 14. After that, when the translucent substrate 16 is further lowered, a contact area between the second adhesive 17 and the adhesive layer 14 is gradually enlarged. In this case, when the drip formed of the second adhesive 17 is in a state of point-contact with the first adhesive layer 14, the translucent substrate 16 is lowered at descending speed at which a wave pattern is not formed on a surface of the drip. This is because, when the wave pattern is generated, bubbles are trapped in the second adhesive 17. The second adhesive 17 is diffused over the entire bottom surface of the translucent substrate 16. There is almost no step between the surface of the first adhesive layer 14 and the top surface of the opening end portion 12, and hence bubbles or voids are not trapped in the step portion. It should be noted that a diameter of a bubble permissible in the adhesive filled between the liquid crystal panel 8 and the translucent substrate 16 is about 100 μm. Therefore, there arises no problem in a bubble having a diameter smaller than 100 μm.

FIG. 4E illustrates a cross-sectional structure in which the translucent substrate 16 is bonded to the top surface of the liquid crystal panel 8, which illustrates the second adhesive curing step. The second adhesive 17 is diffused over the entire bottom surface of the translucent substrate 16, and then ultraviolet rays are irradiated to cure the second adhesive 17. Ultraviolet rays are irradiated for 3,000 to 10,000 mJ/cm². Hardness of the second adhesive 17 after being cured is type A hardness of 1 to 10. Thus, hardness of the second adhesive 17 after being cured has an elastomeric property. The upper polarizing plate 5 is peeled off or damaged as a result of deformation caused by thermal expansion and the like if hardness is considerably high, and impact resistance of the liquid crystal panel 8 decreases if hardness is considerably low.

It should be noted that, in Embodiment 1, the refractive indices of the first adhesive layer 14 and the second adhesive 17 are made to be approximate to refractive indices of the translucent substrate 16 and the upper polarizing plate 5. For this reason, reflection loss of light, which is generated in an interface between the upper polarizing plate 5 and the first adhesive layer 14, an interface between the first adhesive layer 14 and the second adhesive 17, and an interface between the second adhesive 17 and the translucent substrate 16, decreases. For example, the refractive indices of the first adhesive layer 14 and the second adhesive 17 are made to be 1.45 to 1.55. The glass substrate for protection is used as the translucent substrate 16, but the glass substrate for protection can be replaced by a plastic plate or a touch panel. Further, in place of a UV curable adhesive, a thermosetting adhesive or a visible light curable adhesive can be used. Further, as the first adhesive and the second adhesive 17, different types of adhesives selected from a UV curable adhesive, a thermosetting adhesive, and a visible light curable adhesive can be used in combination.

### Embodiment 2

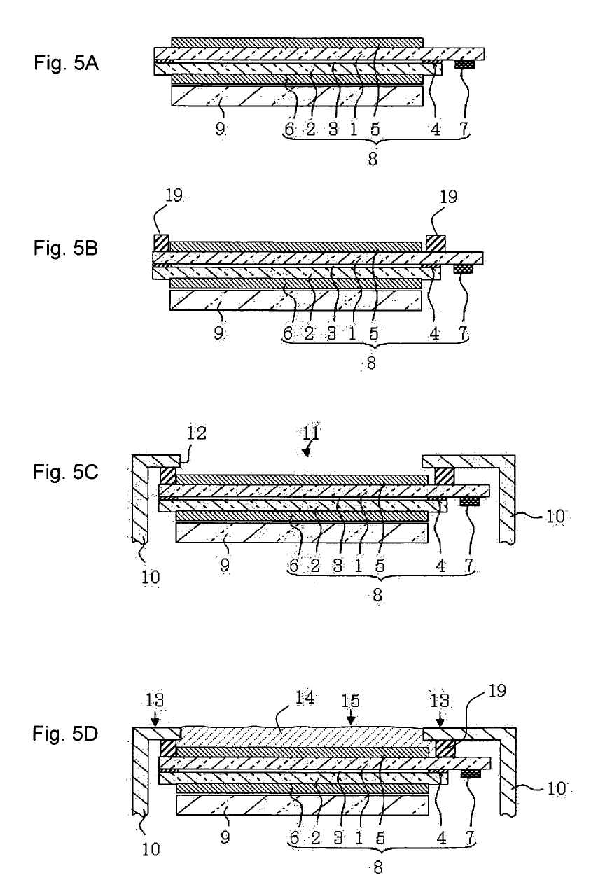

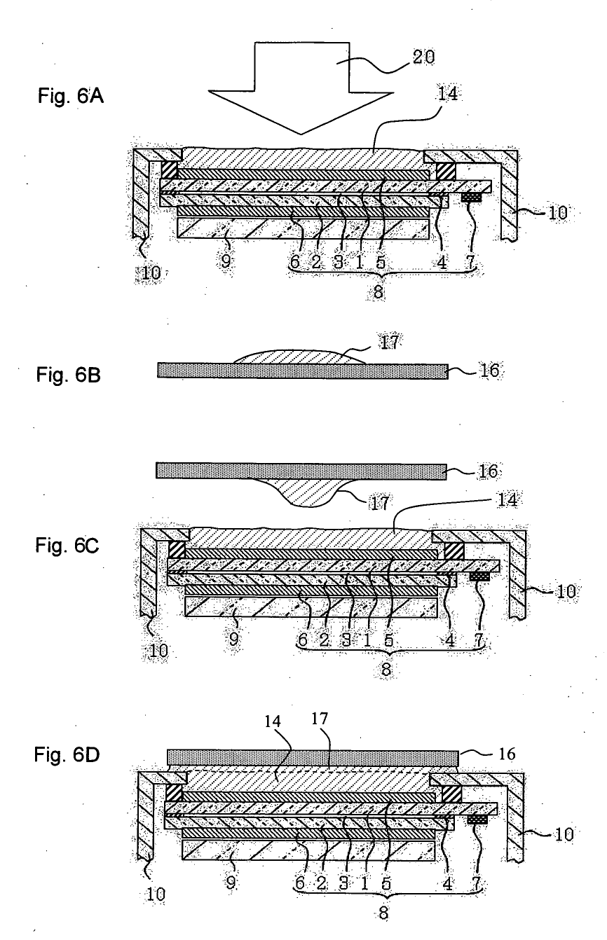

The manufacturing method for a display device according to this embodiment is described with reference to FIGS. 5A to 5D and FIGS. 6A to 6D. FIG. 5A illustrate a cross-sectional structure of the liquid crystal panel 8 and the backlight 9, which illustrates a disposing step. The liquid crystal panel 8 is similar to that of FIG. 4A of Embodiment 1, and hence its description is omitted. FIG. 5B is a cross-sectional view illustrating a state in which a double-sided tape 19 is attached to a top surface of an upper substrate 1 of the liquid crystal panel 8. The double-sided tape is attached to a periphery of the top surface of the upper substrate 1 of the liquid crystal panel 8. FIG. 5C is a cross-sectional view illustrating a state in which the upper substrate 1 of the liquid crystal panel 8 and the frame body 10 are bonded to each other with the double-sided tape 19. The double-sided tape 19 prevents the adhesive from leaking out from the gap between the frame body 10 and the liquid crystal panel 8 when the second adhesive is applied, and functions as a dam.

Then, a concave portion formed of the double-sided tape 19, the opening end portion 12, and the top surface of the liquid crystal panel 8 is applied with the first adhesive to form the first adhesive layer 14. FIG. 5D is a cross-sectional view schematically illustrating a state in which the first adhesive layer 14 is formed, which illustrates a step of applying the first adhesive to form the first adhesive layer in the first adhesive layer forming step. The viscosity of the first adhesive is 1,000 to 6,000 mPa·s. A height of the top surface 15 of the first adhesive when the first adhesive is applied is substantially equal to a height of the top surface 13 of the frame body 10. The first adhesive applied onto the surface of the liquid crystal panel 8 is dammed by the double-sided tape 19, and thus does not leak out down the side surface of the display panel. Irregularities of the surface of the first adhesive are preferably made to be 100 μm or less. The first adhesive is applied, and then an ultraviolet ray 20 is irradiated to cure the first adhesive layer 14. FIG. 6A is a cross-sectional view schematically illustrating a state in which the ultraviolet ray 20 is irradiated to the first adhesive layer 14 to cure the first adhesive layer 14, which illustrates a curing step for the first adhesive of the first adhesive layer forming step. As described above, the first adhesive layer forming step includes the step of applying the first adhesive to form the first adhesive layer 14, and the step of irradiating the first adhesive layer 14 with the ultraviolet ray 20 to cure the first adhesive layer 14.

FIG. 6B is a cross-sectional view illustrating a state in which the surface of the translucent substrate 16 is applied with the second adhesive 17, which illustrates the second adhesive applying step. The second adhesive 17 has the viscosity of 1,000 to 6,000 mPa·s and the refractive index which is substantially the same as that of the first adhesive. FIG. 6C is a cross-sectional view illustrating a state in which the translucent substrate 16 is turned upside down to be bonded to the top surface of the liquid crystal panel 8, which illustrates the bonding step. The translucent substrate 16 is gradually lowered so that the tip of the drip of the second adhesive is made to be in a point-contact state with the surface of the first adhesive layer 14 to gradually enlarge a contact surface therebetween. The descending speed of the translucent substrate 16 is a speed at which a wave pattern is not generated on the surface of the drip. The second adhesive 17 is diffused over the entire bottom surface of the translucent substrate 16. FIG. 6D is a cross-sectional view illustrating a curing step of curing the second adhesive 17. FIG. 6D is similar to FIG. 4E, and thus its description is omitted.

It should be noted that curing of the first adhesive layer 14 and curing of the second adhesive 17 are performed in the separate steps, and thus adhesives of different cure types can be used in combination. For example, a thermosetting adhesive can be used for the first adhesive layer 14, and a UV curable adhesive can be used for the second adhesive 17.

The double-sided tape is attached to the liquid crystal panel 8 in the present invention, but may be attached to the frame body 10.

### Embodiment 3

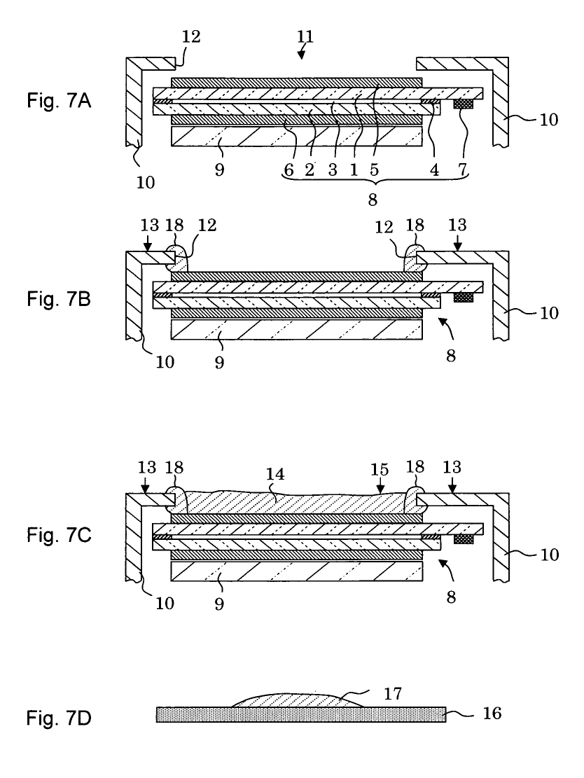

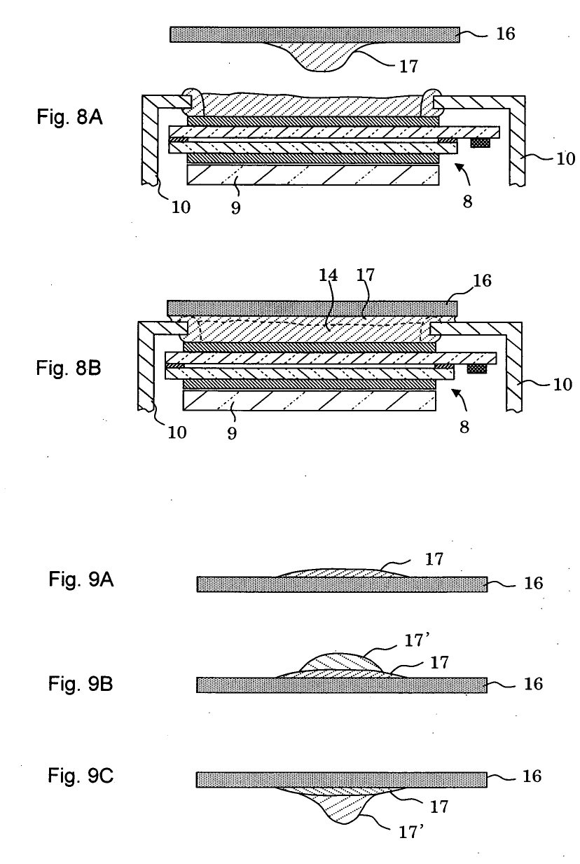

The manufacturing method for a display device according to this embodiment is described with reference to FIGS. 7A to 7D and FIGS. 8A and 8B. FIG. 7A is a cross-sectional view illustrating a state in which the liquid crystal panel 8 is disposed in proximity to the opening end portion 12 of the frame body 10, which illustrates a disposing step. FIG. 7A is similar to FIG. 4A of Embodiment 1, and thus its description is omitted. FIG. 7B is a cross-sectional view illustrating a state in which an adhesive dam 18 made of a third adhesive is formed between the opening end portion 12 and the top surface of the upper polarizing plate 5 of the liquid crystal panel 8. As the third adhesive, a UV curable adhesive having viscosity of 10,000 to 50,000 mPa·s is used. The adhesive dam 18 is made so that the adhesive does not leak out from the gap between the frame body 10 and the liquid crystal panel 8 when the first adhesive is applied. The adhesive dam 18 is formed so as to cover at least the opening end portion 12. An upper end portion of the adhesive dam 18 is preferably formed to be higher than the top surface 13 of the frame body 10. More preferably, the upper end portion of the adhesive dam 18 is made to be higher than the top surface 13 of the frame body 10 by about 0.1 mm. As a result, in the bonding step for the translucent substrate 16, the second adhesive can be filled over the entire bottom surface of the translucent substrate 16.

Then, a concave portion formed of the adhesive dam 18 and the top surface of the liquid crystal panel 8 is applied with the first adhesive to form the first adhesive layer 14. FIG. 7C is a cross-sectional view schematically illustrating a state in which the first adhesive layer 14 is formed. The viscosity of the first adhesive layer 14 is 1,000 to 6,000 mPa·s. The height of the top surface 15 of the first adhesive when the first adhesive is applied is made to be substantially equal to the height of the top surface 13 of the frame body 10. The first adhesive applied onto the surface of the liquid crystal panel 8 is dammed by the adhesive dam 18 and does not leak out downward. Irregularities of the surface of the first adhesive are preferably 100 μm or less. Ultraviolet rays are irradiated after the application of the first adhesive, and then the adhesive dam 18 and the first adhesive are cured to form the first adhesive layer 14. A refractive index of the adhesive dam 18 is substantially equal to that of the first adhesive 14. Accordingly, light can be prevented from being reflected on an interface therebetween.

FIG. 7D is a cross-sectional view illustrating a state in which the surface of the translucent substrate 16 is applied with the second adhesive 17, which illustrates the second adhesive applying step. The second adhesive 17 has viscosity of 1,000 to 6,000 mPa·s and a refractive index which is substantially equal to that of the first adhesive.

FIG. 8A is a cross-sectional view illustrating a state in which the translucent substrate 16 is turned upside down to be bonded to the top surface of the liquid crystal panel 8, which illustrates the bonding step. The translucent substrate 16 is gradually lowered so that a tip of the drip of the second adhesive is caused to be in a state of a point-contact with the surface of the first adhesive layer 14, and a contact surface therebetween is gradually enlarged. Descending speed of the translucent substrate 16 is a speed at which a wave pattern is not generated on the surface of the drip. The contact region of the second adhesive 17 is gradually enlarged to reach the adhesive dam 18. In accordance with a fluid volume or viscosity of the second adhesive 17, diffusion of the second adhesive 17 is stopped at the adhesive dam 18, or the second adhesive 17 is diffused over the entire bottom surface of the translucent substrate 16. FIG. 8B is a cross-sectional view illustrating the curing step of curing the second adhesive 17. FIG. 8B is similar to FIG. 4E, and thus its description is omitted.

### Embodiment 4

The manufacturing method for a display device according to this embodiment is described with reference to FIG. 9A to 9C. This embodiment includes a step of applying the second adhesive 17 onto the surface of the translucent substrate 16 twice in the second adhesive applying step. The disposing step, first adhesive layer forming step, bonding step, and second adhesive curing step other than the above-mentioned step are similar to those of Embodiments 1 to 3, and thus their descriptions are omitted.

FIG. 9A is a cross-sectional view illustrating a state in which the surface of the translucent substrate 16 is applied with the second adhesive 17 as a first layer, which has relatively high viscosity. As the second adhesive 17 applied as the first layer, a UV curable adhesive having viscosity of 5,000 to 10,000 mPa·s is used. FIG. 9B is a cross-sectional view illustrating a state in which a second adhesive 17′, which has relatively low viscosity, is applied as a second layer onto the second adhesive 17 applied as the first layer. As the second adhesive 17′ applied as the second layer, a UV curable adhesive made of a similar material as that of the second adhesive 17 applied as the first layer is used, and viscosity thereof is 1,000 to 6,000 mPa·s. FIG. 9C illustrates a state of a drip of the second adhesive 17′ when the translucent substrate 16 is turned upside down. The second adhesive 17′ applied as the second layer mainly forms a drip.

An application method as described above, in which the first layer is the second adhesive 17 having high viscosity and the second layer is the second adhesive 17′ having low viscosity, is suitable for bonding of the translucent substrate 16 having a large area. The second adhesive 17 applied as the first layer is applied onto the surface in a relatively large area, and the second adhesive 17′ applied as the second layer forms the drip. The formation of the drip prevents bubbles from being trapped. It should be noted that the present invention is not limited to the application of the second adhesive 17 two times, and may adopt application of three times or more times. In such a case, the viscosity of the second adhesive 17 to be applied finally is made to have lower viscosity compared with the second adhesive previously applied, for example, 1,000 to 6,000 mPa·s.

### Embodiment 5

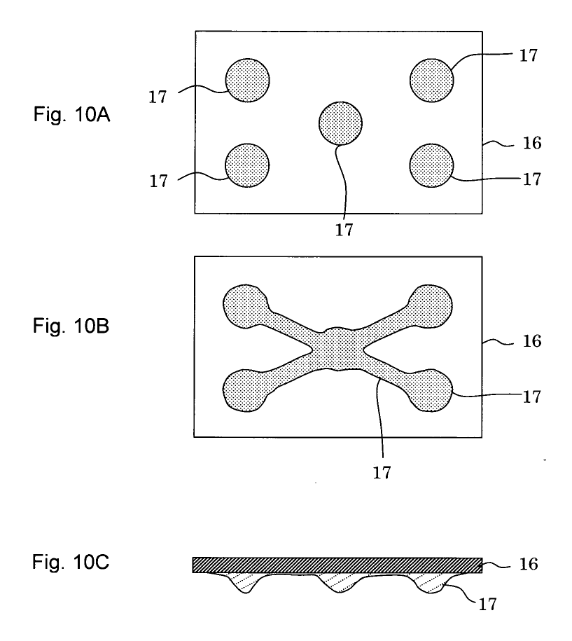

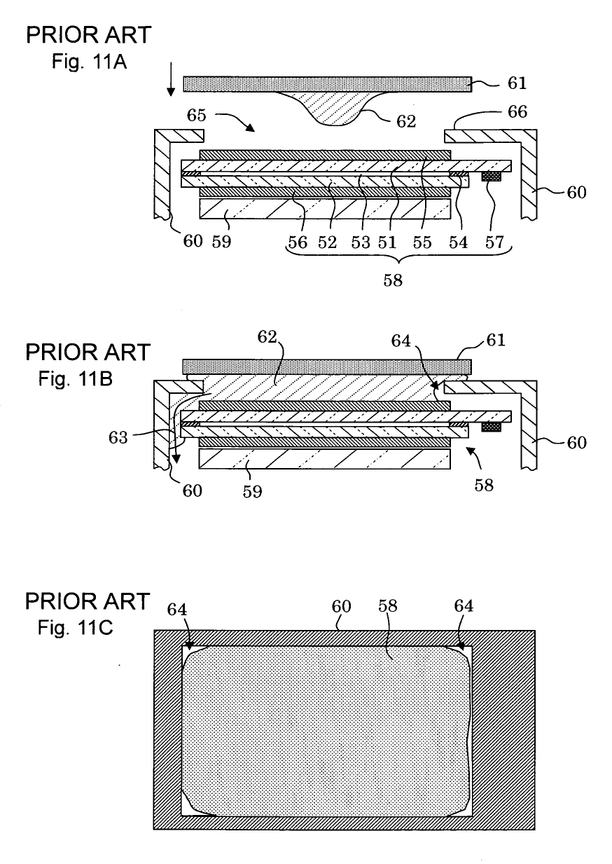

FIGS. 10A to 10C are explanatory views for describing the manufacturing method for a display device according to this embodiment, which illustrate the second adhesive applying step. The disposing step, first adhesive layer forming step, bonding step, and second adhesive curing step are similar to those of Embodiments 1 to 3, and thus their descriptions are omitted.

FIG. 10A is a top view of the translucent substrate 16, which illustrates a state in which the second adhesive 17 is applied to five spots. FIG. 10B illustrates a state in which the second adhesive 17, which is applied to the five spots in an island shape, is further applied to radially connect the five spots in an X-shape. FIG. 10C illustrates a state in which the translucent substrate 16 is turned upside down. Drips are formed in a plurality of spots of the translucent substrate 16. The translucent substrate 16 is gradually lowered so that tips of the drips are made in a state of point-contact with the surface of the liquid crystal panel 8, to thereby enlarge a contact surface over the entire surface. As a result, the translucent substrate 16 having a large area can be bonded to the liquid crystal panel 8 having a large area without trapping bubbles therebetween. It should be noted that, in the present invention, application of the second adhesive 17 is not limited to five spots, and the second adhesive 17 may be applied to a number of spots.

In Embodiment 1 to Embodiment 5 described above, in place of the liquid crystal panel 8, a plasma display panel, an organic EL display panel, or other flat panel can be used. As the translucent substrate 16, a plastic plate, a touch panel, or the like can be used in place of the protective glass. In place of the UV curable adhesive, a thermosetting adhesive or a visible light curable adhesive can be used. Further, for the first adhesive and the second adhesive, among the above-mentioned adhesives, adhesives different from each other can be used in combination.

What is claimed is:

1. A manufacturing method for a display device, comprising:
disposing a display panel inside a frame body that has an opening on its top portion defined by an opening end portion of the frame body;
forming a first adhesive layer made of a first adhesive on an exposed surface of the display panel, the exposed surface being exposed from the opening of the frame body;
applying a second adhesive on a surface of a translucent substrate;
bonding the translucent substrate applied with the second adhesive to a top surface of the display panel including the first adhesive layer formed thereon, the surface of the translucent substrate applied with the second adhesive being a bottom surface; and
curing the second adhesive.

2. A manufacturing method for a display device according to claim 1, wherein the forming the first adhesive layer includes forming, on the exposed surface of the display panel exposed from the opening of the frame body, the first adhesive layer so that a height of the first adhesive layer is substantially equal to a height of a top surface of the opening end portion.

3. A manufacturing method for a display device according to claim 2, further comprising forming, between the frame body and the display panel, an adhesive dam which prevents the first adhesive from leaking down a side surface of the display panel prior to the forming the first adhesive layer.

4. A manufacturing method for a display device according to claim 3, wherein the adhesive dam is formed of a double-sided tape.

5. A manufacturing method for a display device according to claim 3, wherein the adhesive dam is formed of an adhesive.

6. A manufacturing method for a display device according to claim 5, wherein a height of an upper end portion of the adhesive dam is higher than a height of the top surface of the opening end portion.

7. A manufacturing method for a display device according to claims 1, further comprising curing the first adhesive prior to the bonding the translucent substrate.

8. A manufacturing method for a display device according to claim 1, wherein the applying the second adhesive includes applying an adhesive having relatively high viscosity on the surface of the translucent substrate, and thereafter applying an adhesive having relatively low viscosity on the adhesive having relatively high viscosity.

9. A manufacturing method for a display device according to claim 1, wherein the first adhesive and the second adhesive each have cure shrinkage ratio of 1% to 6%.

10. A manufacturing method for a display device according to claim 1, further comprising forming, between the frame body and the display panel, an adhesive dam which prevents the first adhesive from leaking down a side surface of the display panel prior to the forming the first adhesive layer.

11. A manufacturing method for a display device according to claim 10, wherein the adhesive dam is formed of a double-sided tape.

12. A manufacturing method for a display device according to claim 10, wherein the adhesive dam is formed of an adhesive.

13. A manufacturing method for a display device according to claim 12, wherein a height of an upper end portion of the adhesive dam is higher than a height of the top surface of the opening end portion.
